(19) United States
(12) Patent Application Publication
(10) Pub. No.: US 2025/0091102 A1
(43) Pub. Date: Mar. 20, 2025

(54) SEWER CLEANING SYSTEM

(71) Applicant: iPEK International GmbH, Sulzberg (DE)

(72) Inventors: Thomas Nagel, Hirschegg (AT); Florian Guggemos, Kempten (DE)

(21) Appl. No.: 18/883,970

(22) Filed: Sep. 12, 2024

(30) Foreign Application Priority Data
Sep. 14, 2023 (DE) 10 2023 124 806.5

(51) Int. Cl. B08B 9/032; E03F 9/00; G06V 10/82; G06V 20/50; H04N 7/18; H04N 23/50

(52) U.S. Cl. CPC B08B 9/0325; E03F 9/007; G06V 10/82; G06V 20/50; H04N 7/183; H04N 23/555; B08B 2209/032

(57) ABSTRACT

Provided is a sewer cleaning system with a flushing nozzle which comprises a camera and a data processing unit, wherein the data processing unit is adapted to receive images of the sewer pipe taken by the camera, to analyze the received images in order to determine a cleaning state of the sewer pipe, and to generate a signal based upon the determined cleaning state and to transmit it to a display unit, wherein the signal is indicative of the determined cleaning state, wherein the display unit is adapted to cause a visualization of the received signal on the display unit based upon the received signal. Furthermore, a correspondingly designed method is provided.

### CROSS-REFERENCE TO RELATED APPLICATIONS

This application claims priority to German Patent Application Serial No. DE 10 2023 124 806.5, filed Sep. 14, 2023, the entire disclosure of which is hereby incorporated herein by reference in its entirety.

### FIELD OF THE INVENTION

The invention relates to a sewer cleaning system comprising a flushing nozzle coupled to a flushing hose, wherein the flushing nozzle is designed to carry out a cleaning of the sewer pipe when the flushing nozzle is supplied with a flushing medium via the flushing hose. Furthermore, the invention relates to a method for cleaning a sewer or a sewer pipe.

### BACKGROUND OF THE INVENTION

Sewer systems, especially wastewater pipes, must be cleaned at regular intervals or when necessary. For this purpose, in the sewer pipe to be cleaned, so-called flushing nozzles are placed, which are supplied with a flushing medium, such as water, preferably with an overpressure. Such flushing nozzles may have a camera that takes pictures continuously or at regular intervals during the flushing process and stores them in a memory of the camera. After completion of a flushing process, the images can be checked by an operator outside the sewer—for example, in an inspection vehicle. If cleaning is poor, the flushing process must be repeated. However, there is no guarantee that a further flushing process will not be necessary. Repeated flushing is more time-consuming and also leads to increased consumption of flushing water and overall higher energy consumption.

### OBJECT OF THE INVENTION

The object of the present invention is therefore to provide solutions that can ensure more effective cleaning of sewers.

### SUMMARY OF THE INVENTION

This object is achieved with a sewer cleaning system and a method for cleaning sewers according to the independent claims. Advantageous embodiments of the invention are set forth in the specific dependent claims.

A sewer cleaning system is provided, comprising
a flushing nozzle which is movable or displaceable in a sewer pipe and which is coupled to a flushing hose, wherein the flushing nozzle is designed to clean the sewer pipe when the flushing nozzle is supplied with a flushing medium via the flushing hose, and
a display unit with a receiving unit,
   wherein
the flushing nozzle comprises a transmitting unit, a camera, and a data processing unit,
the data processing unit is coupled to the camera and the transmitting unit,
the transmitting unit is adapted to establish a communications connection with the receiving unit of the display unit,
the data processing unit is adapted
to receive images of the sewer pipe taken by the camera,
to analyze the images received in order to determine the cleaning status of the sewer pipe (or is adapted to determine the cleaning status), and
to generate a signal based upon the determined cleaning status and to transmit (the signal) via the transmitting unit to the receiving unit of the display unit, wherein the signal is indicative of the determined cleaning status, and
the display unit is adapted to cause a visualization of the received signal on the display unit based upon the signal received from the receiving unit, wherein the visualization of the signal indicates the cleaning status of the sewer pipe.

It is advantageous if the sewer cleaning system further comprises a control device for controlling the supply of the flushing medium to the flushing nozzle.

The data processing unit may comprise an artificial intelligence, in particular an artificial neural network, wherein the artificial intelligence is trained to recognize the cleaning status of the sewer pipe in the received images.

The camera may be a video camera.

The communications connection may be a wired or wireless communications connection.

The cleaning state may comprise two cleaning states, preferably three cleaning states, wherein the signal is indicative of one of the two cleaning states, preferably one of the three cleaning states.

The visualization of the received signal on the display unit may include displaying a signal lamp on the display unit, wherein each signal lamp color is associated with a cleaning state.

The control device may be adapted to control the supply of the flushing medium to the flushing nozzle as a function of the generated signal. In one embodiment, it is possible for the control device to control the actuation of the flushing nozzle without the generated signal being visualized on the display unit.

The flushing nozzle may further comprise a memory device coupled to the data processing unit, wherein the received images are stored in the memory device.

Furthermore, a method is provided for controlling a flushing nozzle that is movable or displaceable in a sewer pipe, wherein the flushing nozzle comprises a transmitting unit, a camera, and a data processing unit, wherein
the camera takes pictures of the sewer pipe,
the data processing unit
receives the images taken by the camera,
analyzes the images received to determine the cleaning status of the sewer pipe,
generates a signal based upon the determined cleaning condition and transmits it via the transmitting unit to a receiving unit, wherein the signal is indicative of the determined cleaning condition, and
the flushing nozzle is controlled as a function of the signal received at the receiving unit.

It may be advantageous if, based upon the signal received by the receiving unit, a visualization of the received signal is displayed on a display unit, wherein the visualization of the signal indicates the cleaning state of the sewer pipe, wherein controlling the flushing nozzle as a function of the signal received at the receiving unit comprises controlling the flushing nozzle as a function of the visualization displayed on the display unit.

The data processing unit may comprise an artificial intelligence, in particular an artificial neural network, wherein the artificial intelligence is trained to recognize the cleaning status of the sewer pipe in the received images.

The cleaning state may comprise two cleaning states, preferably three cleaning states, wherein the signal is indicative of one of the two cleaning states, preferably one of the three cleaning states, and wherein, upon visualization of the received signal on the display unit, a signal lamp is displayed on the display unit, wherein each signal lamp color is assigned to a cleaning state.

By means of a control device, the supply of a flushing medium to the flushing nozzle can be controlled, in particular as a function of the signal generated.

The flushing nozzle may further comprise a memory device coupled to the data processing unit, wherein the received images are stored in the memory device.

### BRIEF DESCRIPTION OF THE DRAWINGS

Further details and features of the invention as well as specific, in particular, advantageous, exemplary embodiments of the invention will be apparent from the following description in conjunction with the drawing. In the figures:

FIG. 1 shows a sewer cleaning system according to the invention with a flushing nozzle arranged in the sewer;

FIG. 2 shows a flushing nozzle in a detailed view;

FIGS. 3A-3C show three examples of cleaning states during a flushing process with corresponding signal lamps displayed on a display unit; and

FIGS. 4A and 4B show two further examples of cleaning states during a flushing process with an alternative display of corresponding signal lamps shown on a display unit.

### DETAILED DESCRIPTION OF THE INVENTION

The invention advantageously makes it possible to carry out a cleaning or flushing process in a sewer using a flushing nozzle, while ensuring that the cleaning or flushing process does not have to be repeated again—for example, due to an unsatisfactory cleaning result.

On a display unit located outside the sewer to be cleaned, e.g., in a sewer inspection vehicle, the current cleaning status in the area of the flushing nozzle is visualized—for example, in the form of a signal lamp (green, yellow, or red). The flushing nozzle can remain in the current sewer section until the signal lamp turns green. The operator of the flushing nozzle can then cause the flushing nozzle to be pushed further into the sewer or pulled out of the sewer. If the signal lamp changes to yellow or red when the flushing nozzle is pushed forwards or pulled back, the flushing nozzle remains in this section of the sewer until the signal lamp changes to green again. The operator of the flushing nozzle can thus easily control the entire flushing process using the signal lamp on the display unit. If the signal lamp for the entire sewer section to be cleaned is green, then this sewer section has been completely cleaned.

The operator could also check the current cleaning status using a video image transmitted from the flushing nozzle to the display unit. However, this requires a very high bandwidth, which is usually not available when using wireless transmission technologies during a flushing process. The flushing water can also result in the transmission of a video signal being impossible or only possible temporarily. Alternatively, a wired transmission of the video signal would be possible; however, in addition to the flushing hose, a data cable would also have to be entrained, which could be damaged in the harsh environment during a flushing process or could hinder the flushing process itself.

Since, according to the invention, only a signal lamp is shown on the display unit, there is no need to transmit image data from the sewer during the cleaning process. The operator still receives sufficient information about the current cleaning status. Very small amounts of data are sufficient to transmit a signal that is indicative of the current cleaning status and can be transmitted wirelessly from the flushing nozzle to the display unit. If a signal lamp is used that is intended to visualize only two states (green=cleaned and red=not cleaned), one bit is sufficient as an information carrier. Tests have shown that sufficiently stable wireless data transmission of these small amounts of data is possible even during a flushing process in extremely harsh environments. High latencies or long signal propagation times can be ignored due to the slow cleaning process.

According to the invention, the signal which is indicative of the current cleaning state is derived from image data provided by a camera of the flushing nozzle. Here, too, the transmission of image data to the display device can advantageously be dispensed with, since the signal is derived from the image data by a data processing unit of the flushing nozzle.

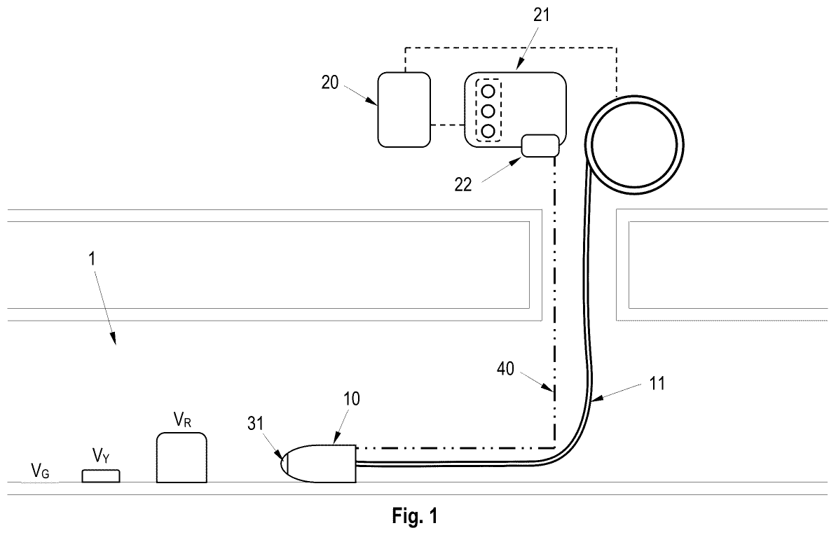

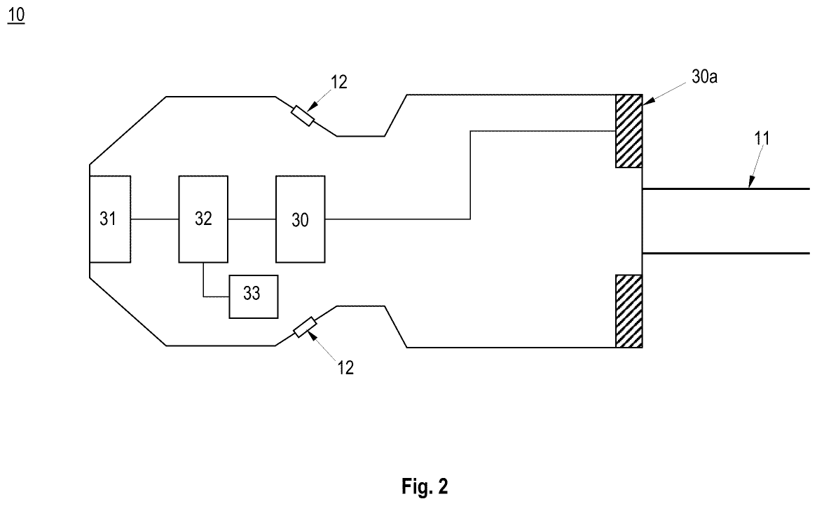

FIG. 1 shows a sewer cleaning system according to the invention with a flushing nozzle 10 arranged in the sewer 1, wherein the flushing nozzle itself is shown in a detailed view in FIG. 2.

The flushing nozzle 10 is coupled to a flushing hose 11, which may be designed as a high-pressure flushing hose, via which a flushing medium, e.g., water, is supplied to the flushing nozzle. Several nozzles 12 may be provided on the flushing nozzle, which are preferably arranged radially around the flushing nozzle. These nozzles are connected to the flushing medium supply at the back of the flushing nozzle. In the flushing nozzle 10 shown in FIG. 2, the nozzles 12 are designed as so-called jet thrust nozzles, which on the one hand serve to clean the sewer, and on the other cause a forward movement of the flushing nozzle due to the thrust impulse of the emerging flushing medium. Additional nozzles or other nozzles may be arranged on the flushing nozzle.

The flushing nozzle 10 has a camera 31 at its front end, which may be designed as a video camera. According to the invention, the camera 31 may also be designed as a “normal” camera with which images are taken at regular intervals.

The flushing nozzle 10 is coupled or can be coupled to a receiving unit 22 of a display unit 21 via a communications connection 40, wherein the display unit 21 is arranged outside the sewer—for example, in an inspection vehicle (not shown). Preferably, the communications connection 40 is a wireless connection. However, a wired communications connection may also be provided; however, a wireless communications connection is more advantageous.

The flushing nozzle has a transmitting unit 30, via which a communications connection is established with the receiving unit 22 of the display unit 21. When providing a wireless communications connection, the transmitting unit 30 is coupled to one or more transmitting/receiving antennas 30a, which are preferably arranged on the rear side of the flushing nozzle.

The display unit 21 may, for example, be a tablet or a stationary screen. The cleaning status of the sewer pipe in the area in which the flushing nozzle 10 is located or which is detected by the camera 31 of the flushing nozzle 10 is displayed on the display unit 21. According to the invention, it is provided that the cleaning state be visualized as a type of signal lamp 23, wherein a green signal lamp indicates that there is no contamination, a yellow signal lamp indicates that there is medium contamination, and a red signal lamp indicates that there is severe contamination.

According to the invention, the term “signal lamp” is also understood to include symbols other than signal lamp-like symbols. What is essential for the invention is that a few different symbols are provided, each of which is assigned a specific cleaning state and which are easy to distinguish and perceive by the operator of the system. Instead of the three signal lamp colors, the three digits 0, 1, and 2 can be used, with 0=no contamination, 1=medium contamination, and 2=severe contamination. Instead of three levels of contamination, two levels of contamination (no contamination and contamination) or more than three levels of contamination may be provided.

Although images or a video from the camera 31 are available at the flushing nozzle, according to the invention, it is not the video images that are displayed on the display unit 21, but, rather, the signal lamp symbols corresponding to the contamination. This has the advantage that the transmission of video images is not necessary. The operator no longer has to evaluate the video images (which can be a complex process and requires considerable experience on the part of the operator) to decide whether contamination is present, but has to concentrate only on the signal lamp symbols. A cleaning process can thus be carried out effectively and, above all, efficiently even by an inexperienced operator.

In FIG. 1, three places in the sewer are shown as examples, which show a contamination or no contamination:

V_{R}—heavy contamination in the area of the flushing nozzle or in the detection range of the camera: In this case, a red signal lamp would be displayed on the display unit 21.

V_{Y}—medium contamination in the area of the flushing nozzle or in the detection range of the camera: In this case, a yellow signal lamp would be displayed on the display unit 21.

V_{G}—no contamination in the area of the flushing nozzle or in the detection range of the camera: In this case, a green signal lamp would be displayed on the display unit 21.

Based upon the signal lamp displayed on the display unit 21 (color of the signal lamp), the operator can decide whether the location where the flushing head 10 is located needs to be cleaned further (if the signal lamp shows yellow or red) or whether the location where the flushing head 10 is located has been sufficiently cleaned (if the signal lamp shows green), and the flushing head can be moved further in the sewer.

Furthermore, the system may comprise a control device 20 for controlling the supply of the flushing nozzle 10 with the flushing medium. This control device can, for example, be operated by the operator of the system. The control device 20 can be used, for example, to monitor or control the pressure with which the flushing medium is supplied to the flushing nozzle 10. The control device can also be used to control the rolling up or unrolling of the flushing hose 11 onto or from a hose reel.

In a particular embodiment of the invention, the control device 20 is coupled to the display unit 21 such that the control device 20 is supplied with information about the cleaning state displayed on the display unit. In this case, the control device 20 may be adapted to control, even without manual intervention, for example, the pressure with which the flushing medium is supplied to the flushing nozzle 10 and/or the rolling up or unrolling of the flushing hose 11 onto or from a hose reel. For example, the control device 20 may be adapted to control the pressure with which the flushing medium is supplied to the flushing nozzle 10 as a function of the signal lamp color (e.g., to reduce the pressure when the signal lamp shows green).

According to the invention, the flushing nozzle has a data processing unit 32 which is coupled on the one hand to the camera 31, and on the other to the transmitting unit 30. The data processing unit 32 receives the images of the sewer pipe 1 recorded by the camera 31 (e.g., a video signal or video images). The received images are analyzed by the data processing unit 32 to determine a cleaning status of the sewer pipe 1. Based upon the determined cleaning status, the data processing unit generates a signal and sends it via the transmitting unit 30 to the receiving unit 22 of the display unit 21. The signal generated by the data processing unit is indicative of the determined cleaning status, i.e., the signal contains information about the cleaning status of the sewer section in which the flushing head is located or which is recorded by the camera. Based upon this signal, the display unit is prompted to visualize the cleaning status, e.g., in the form of a signal lamp. In other words, the signal generated by the data processing unit and transmitted to the display unit controls the signal lamp on the display unit. If a distinction is made only between “contaminated” and “uncontaminated,” one bit is sufficient as the information carrier in the signal.

The analysis of the images received by the data processing unit 32 can be accomplished with the aid of image or pattern recognition methods known per se. However, it may be advantageous if the data processing unit 32 comprises an artificial intelligence, in particular an artificial neural network, which is trained to recognize the cleaning status or the degree of contamination of the sewer pipe 1 in the received images. For this purpose, the artificial neural network is trained or taught using training data that include recordings from a large number of different sewer pipe sections in different cleaning states.

The artificial neural network can also be trained to recognize artifacts in the captured image data that are not contamination. For example, a radially circumferential bead at the junction of two pipes is not a contamination, but a seal. The artificial neural network then recognizes that there is no contamination. Accordingly, the data processing unit will then not generate a signal indicative of contamination, or will generate a signal indicative of “no contamination.” Another example of this would be standing water in the sewer bed.

The data processing unit 32 may be coupled to a memory device 33, which is also arranged in the flushing nozzle. The images or video images recorded by the camera can be stored in the memory device 33. After completion of the flushing process, the image data stored in the memory device 33 can be read out, for example, for documentation purposes. However, the image data stored in the memory device 33 can also be used to further train the artificial neural network, and thus improve the quality of the automatic detection of contamination.

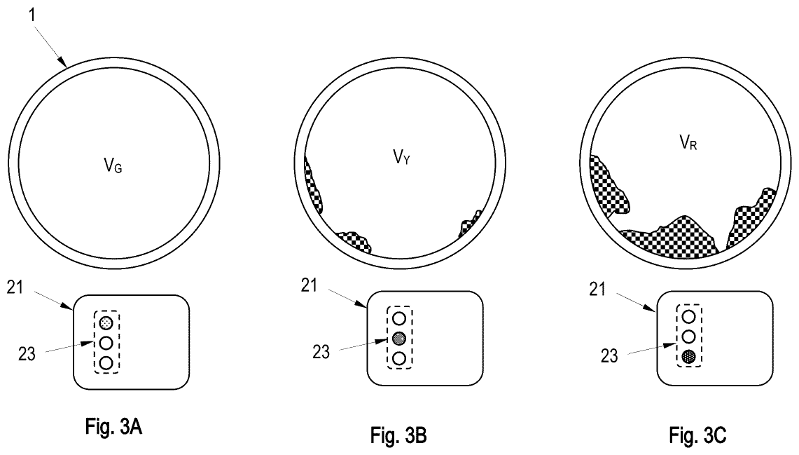

FIGS. 3A-3C show three examples of cleaning states during a flushing process, with corresponding signal lamps that are displayed on a display unit. In FIG. 3A, a clean sewer section V_{G} is shown. Accordingly, a green signal lamp 23 is displayed on the display unit 21. FIG. 3B shows a moderately contaminated sewer section V_{Y}, such that a yellow signal lamp 23 is displayed on the display unit 21. Finally, FIG. 3C shows a heavily contaminated sewer section V_{R} so that a red signal lamp 23 is displayed on the display unit 21. In this example, a familiar signal lamp symbol with the three colors red, yellow, and green is displayed on the display unit 21.

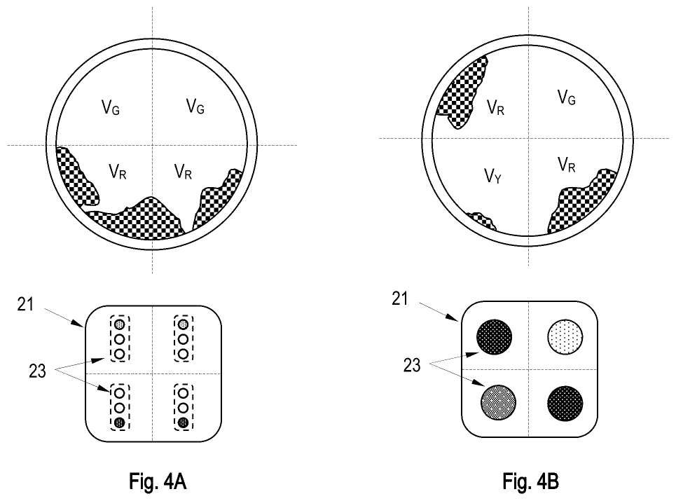

FIGS. 4A and 4B show two further examples of cleaning states during a flushing process, with an alternative display of corresponding signal lamps shown on a display unit.

The artificial neural network has been trained not only to detect contamination or a degree of contamination in the captured images, but also in which quadrant of the image which contamination is located. This can be advantageous in the case where the water jet can be directed in a specific direction using the flushing nozzle.

In FIG. 4A, the section of the sewer pipe in the two lower quadrants is heavily contaminated, while the sewer pipe in the two upper quadrants is clean. Here, the data processing unit may be adapted to generate a corresponding signal or data for each quadrant and then transmit it to the display unit. In the example in FIG. 4A, the data would include information that the two lower quadrants are heavily contaminated, and the two upper quadrants are clean. Separate signal lamps can then be displayed on the display unit 21 for each quadrant, which are placed on the display unit according to the quadrants. Therefore, a red signal lamp is displayed at the bottom left and bottom right, while a green signal lamp is displayed at the top left and top right. The operator can thus specifically initiate cleaning of the lower half of the pipe (provided the flushing nozzle is suitable for this purpose).

In FIG. 4B, the section of the sewer pipe in the upper left and lower right quadrants is heavily contaminated. The lower left quadrant is moderately contaminated, and the upper right quadrant is uncontaminated. The display unit 21 can then display a corresponding symbol for each quadrant, which is placed on the display unit according to the quadrants. In this example, no signal lamp symbols are provided, but, rather, colored dots or areas. Therefore, a red filled circle is displayed at the top left and bottom right, a yellow filled circle is displayed at the bottom left, and a green filled circle is displayed at the top right. Here, too, the operator can specifically initiate cleaning of the respective areas (provided the flushing nozzle is suitable for this).

With the invention, a flushing process can be considerably simplified and accelerated. Errors due to misinterpretation of recorded images by the operator are avoided, because the basis for determining whether a sewer section needs to be cleaned or further cleaned are simple graphic symbols, such as a signal lamp symbol. The consumption of flushing water can be reduced because cleaning takes place only where the signal lamp is red or yellow. For sections where the signal lamp is green, the supply of flushing water to the flushing nozzle can be stopped completely, if appropriate.

We claim:

1. A sewer cleaning system, comprising
a flushing nozzle which is movable or displaceable in a sewer pipe and which is coupled to a flushing hose, wherein the flushing nozzle is designed to clean the sewer pipe when the flushing nozzle is supplied with a flushing medium via the flushing hose, and
a display unit with a receiving unit, wherein
the flushing nozzle comprises a transmitting unit, a camera, and a data processing unit,
the data processing unit is coupled to the camera and to the transmitting unit,
the transmitting unit is adapted to establish a communications connection with the receiving unit of the display unit,
the data processing unit is adapted
to receive images of the sewer pipe taken by the camera,
to analyze the images received in order to determine the cleaning status of the sewer pipe, and
to generate a signal based upon the determined cleaning state and to transmit it via the transmitting unit to the receiving unit of the display unit, wherein the signal is indicative of the determined cleaning state, and
the display unit is adapted to cause a visualization of the received signal on the display unit based upon the signal received from the receiving unit, wherein the visualization of the signal indicates the cleaning status of the sewer pipe.

2. The sewer cleaning system according to claim 1, further comprising a control device for controlling the supply of the flushing medium to the flushing nozzle.

3. The sewer cleaning system according to claim 1, wherein the data processing unit comprises an artificial intelligence, in particular an artificial neural network, wherein the artificial intelligence is trained to recognize the cleaning state of the sewer pipe in the received images.

4. The sewer cleaning system according to claim 1, wherein the camera is a video camera.

5. The sewer cleaning system according to claim 1, wherein the communications connection is a wireless communications connection.

6. The sewer cleaning system according to claim 1, wherein the cleaning state comprises two cleaning states, preferably three cleaning states, wherein the signal is indicative of one of the two cleaning states, preferably one of the three cleaning states.

7. The sewer cleaning system according to claim 1, wherein the visualization of the received signal on the display unit comprises displaying a signal lamp on the display unit, wherein each signal lamp color is associated with a cleaning state.

8. The sewer cleaning system according to claim 2, wherein the control device is adapted to control the supply of the flushing medium to the flushing nozzle as a function of the generated signal.

9. The sewer cleaning system according to claim 1, wherein the flushing nozzle further comprises a memory device which is coupled to the data processing unit, wherein the received images are stored in the memory device.

10. A method for controlling a flushing nozzle which is movable or displaceable in a sewer pipe, wherein the flushing nozzle comprises a transmitting unit, a camera, and a data processing unit, wherein
the camera takes pictures of the sewer pipe,
the data processing unit
receives the images taken by the camera,
analyses the images received to determine the cleaning status of the sewer pipe,
based upon the determined cleaning state, a signal is generated and transmitted via the transmitting unit to a receiving unit, wherein the signal is indicative of the determined cleaning state, and
the flushing nozzle is controlled as a function of the signal received at the receiving unit.

11. The method according to claim 10, wherein, based upon the signal received by the receiving unit, a visualization of the received signal is displayed on a display unit, wherein the visualization of the signal indicates the cleaning state of the sewer pipe, wherein controlling the flushing nozzle as a function of the signal received at the receiving unit comprises controlling the flushing nozzle as a function of the visualization displayed on the display unit.

12. The method according to claim 10, wherein the data processing unit comprises an artificial intelligence, in particular an artificial neural network, wherein the artificial intelligence is trained to recognize the cleaning state of the sewer pipe in the received images.

13. The method according to claim 11, wherein the cleaning state comprises two cleaning states, preferably three cleaning states, wherein the signal is indicative of one of the two cleaning states, preferably one of the three cleaning states, and wherein, upon visualization of the received signal on the display unit, a signal lamp is displayed on the display unit, wherein each signal lamp color is assigned to a cleaning state.

14. The method according to claim 10, wherein the supply of a flushing medium to the flushing nozzle is controlled by means of a control device, in particular as a function of the generated signal.

15. The method according to claim 10, wherein the flushing nozzle further comprises a memory device which is coupled to the data processing unit, wherein the received images are stored in the memory device.
